(19) United States
(12) Patent Application Publication
(10) Pub. No.: US 2022/0170760 A1
(43) Pub. Date: Jun. 2, 2022

(54) METHOD, APPARATUS, AND COMPUTER PROGRAM PRODUCT FOR ANONYMIZED ESTIMATION OF PARKING AVAILABILITY

(71) Applicant: HERE GLOBAL B.V., Eindhoven (NL)

(72) Inventor: Stefano BENNATI, Zurich (CH)

(21) Appl. No.: 17/108,614

(22) Filed: Dec. 1, 2020

(51) Int. Cl. G01C 21/36; G01C 21/30; G08G 1/14

(52) U.S. Cl. CPC G01C 21/3685; G08G 1/141; G08G 1/145; G01C 21/30

(57) ABSTRACT

Embodiments described herein relate to anonymization of parking events such that parking events may be used by location-based service providers without revealing a target associated with the respective parking events. Methods may include: receiving an indication of a parking event; map-matching the parking event to a parking event road segment; identifying candidate road segments, wherein the candidate road segments are connected directly or indirectly to the parking event road segment; selecting a road segment of the candidate road segments; updating the parking event to be an updated parking event associated with the selected road segment; and providing the updated parking event to a location-based service provider.

### TECHNOLOGICAL FIELD

An example embodiment of the present disclosure relates to anonymizing parking availability information, and more particularly, to introduce a privacy enhancing algorithm that anonymizes parking availability information from a user through leveraging information about a road network.

### BACKGROUND

Service providers and device manufacturers (e.g., wireless, cellular, navigation, etc.) are continually challenged to deliver value and convenience to consumers by providing compelling and useful services. Location-based services have been developed to provide users with useful and relevant information regarding route planning and to facilitate route guidance along the way. Substantially static data regarding roadways is used in conjunction with dynamic data, such as traffic, construction, and incident information to provide accurate and timely information to a driver to help route planning and decision making.

Data received from infrastructure monitoring systems and crowd-sourced data has become ubiquitous and may be available for facilitating route guidance and navigation system information. However, this data can be mined to provide various other services to users and to grow the availability of location-based services. The provision of location-based services is dependent upon understanding the location of a user requesting the services. Maintaining anonymity while also being able to access location-based services is a challenge.

Parking availability information requires a high degree of accuracy and certainty. Obtaining information from mobile devices including vehicles regarding parking availability may pose privacy risks due to the nature of a parking event identifying an origin and/or destination for a person, but also mobility information relating to the person.

### BRIEF SUMMARY

A method, apparatus, and computer program product are provided in accordance with an example embodiment described herein for anonymizing parking availability information, and more particularly, for introducing a privacy enhancing algorithm that anonymizes parking availability information from a user through leveraging information about a road network. According to an example embodiment, an apparatus is provided including at least one processor and at least one memory including computer program code, the at least one memory and computer program code configured to, with the processor, cause the apparatus to at least: receive an indication of a parking event; map-match the parking event to a parking event road segment; identify candidate road segments, where the candidate road segments are connected directly or indirectly to the parking event road segment; select a road segment of the candidate road segments; update the parking event to be an updated parking event associated with the selected road segment; and provide the updated parking event to a location-based service provider.

According to some embodiments, causing the apparatus to provide the updated parking event to a location-based service provider includes causing the apparatus to enable the location-based service provider to use the updated parking event in establishing available parking within a road network. The candidate road segments may include road segments of routes that include the parking event road segment. The candidate road segments may be afforded a weight, where causing the apparatus to select the road segment of the candidate road segments may include causing the apparatus to select the road segment of the candidate road segments based, at least in part, on the weights of the candidate road segments. The weight may be based, at least in part, on a functional class of a respective candidate road segment. The weight may be based, at least in part, on a presence of parking spaces along a respective candidate road segment. The road segment of the candidate road segments may be selected based, at least in part, on a distance from the parking event road segment. The candidate road segments may be identified based, at least in part, on road network information from map data.

Embodiments provided herein include a computer program product having at least one non-transitory computer-readable storage medium having computer-executable program code portions stored therein, the computer-executable program code portions including program code instructions to: receive an indication of a parking event; map-match the parking event to a parking event road segment; identify candidate road segments, where the candidate road segments are connected directly or indirectly to the parking event road segment; select a road segment of the candidate road segments; update the parking event to be an updated parking event associated with the selected road segment; and provide the updated parking event to a location-based service provider. The program code instructions to provide the updated parking event to a location-based service provider may include program code instructions to enable the location-based service provider to use the updated parking event in establishing available parking within a road network.

According to some embodiments, the candidate road segments may include road segments of routes that include the parking event road segment. The candidate road segments may be afforded a weight, where the program code instructions to select the road segment of the candidate road segments may include program code instructions to select the road segment of the candidate road segments based, at least in part, on the weights of the candidate road segments. The weight may be based, at least in part, on a functional class of a respective candidate road segment. The weight may be based, at least in part, on a presence of parking spaces along a respective candidate road segment. The selected road segment of the candidate road segments may be selected based, at least in part, on a distance from the parking event road segment. The candidate road segments may be identified based, at least in part, on road network information from map data.

Embodiments provided herein include a method including: receiving an indication of a parking event; map-matching the parking event to a parking event road segment; identifying candidate road segments, where the candidate road segments are connected directly or indirectly to the parking event road segment; selecting a road segment of the candidate road segments; updating the parking event to be an updated parking event associated with the selected road segment; and providing the updated parking event to a location-based service provider. Providing the updated parking event to a location-based service provider may include enabling the location-based service provider to use the updated parking event in establishing available parking within a road network. The candidate road segments may include road segments of routes that include the parking event road segment. The candidate road segments may be afforded a weight, where selecting the road segment of the candidate road segments may include selecting the road segment of the candidate road segments based, at least in part, on the weights of the candidate road segments.

Embodiments provided herein include an apparatus including: means for receiving an indication of a parking event; means for map-matching the parking event to a parking event road segment; means for identifying candidate road segments, where the candidate road segments are connected directly or indirectly to the parking event road segment; means for selecting a road segment of the candidate road segments; updating the parking event to be an updated parking event associated with the selected road segment; and means for providing the updated parking event to a location-based service provider. The means for providing the updated parking event to a location-based service provider may include means for enabling the location-based service provider to use the updated parking event in establishing available parking within a road network. The candidate road segments may include road segments of routes that include the parking event road segment. The candidate road segments may be afforded a weight, where the means for selecting the road segment of the candidate road segments may include means for selecting the road segment of the candidate road segments based, at least in part, on the weights of the candidate road segments.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates a communications diagram in accordance with an example embodiment of the present disclosure;

FIG. 2 is a block diagram of an apparatus that may be specifically configured for anonymizing parking availability information generated from probe data in accordance with an example embodiment of the present disclosure;

FIG. 3 illustrates a map with a parking event, a destination, and routes to parking near the destination according to an example embodiment of the present disclosure;

FIG. 4 illustrates the map of FIG. 3 with the candidate road segments that are candidates for the updated parking event according to an example embodiment of the present disclosure; and

FIG. 5 is a flowchart of a method for anonymizing parking availability information according to an example embodiment of the present disclosure.

### DETAILED DESCRIPTION

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present disclosure.

Mobility data may be defined as a set of points or probe data points, each of which includes at least a latitude, longitude, and timestamp. Additional information may be associated with the probe data points, such as speed, heading, or other data. A trajectory includes a set of probe data points, where probe data points of a trajectory may include a trajectory identifier that associates the probe data points with one another. Mobility data captured in trajectories can be partitioned in a set of trajectories (trajectory data), each of which identifies the movement of a user over time. Mobility data may further include origins, destinations, and waypoints of a user. An origin, destination, or a waypoint may include a parking location for the vehicle of a user. The parking location may be considered sensitive information for which privacy is a concern. Parking location may enable an adversary to learn a home location or work location for a user, or identify other sensitive locations, such as if a user is visiting a hospital, for example.

A method, apparatus, and computer program product are provided herein in accordance with an example embodiment for anonymizing parking availability information, and more particularly, for introducing a privacy enhancing algorithm that anonymizes parking availability information from a user through leveraging information about a road network. Location-based services are useful to a variety of consumers who may employ location-based services for a wide range of activities. Services such as the identification of parking availability proximate a point-of-interest, a destination, or along a route provide great value to a user and can save a user time and energy.

While location-based services are desirable for both consumers and for service providers, consumers are often concerned with the amount of information shared about their routines and activities. Thus, while consumers and service providers want to engage with location-based services, consumers generally desire to maintain some degree of privacy. Embodiments described herein provide a method, apparatus, and computer program product through which location information and more specifically, parking information can be gathered and shared in a manner that anonymizes the source of the information and makes unmasking of the source or target difficult.

Location-based services (LBS) such as real-time traffic information, fleet management, and navigation among others, are based on the analysis of mobility data that users of such services provide. Mobility data is associated with a privacy level and accuracy value. An accuracy value is based on the intrinsic utility of data toward the generation of location-based services. The privacy value reflects the sensitive information that mobility data reveals about a user's habits, behaviors, and personal information such as their home and/or work address.

Location-based service providers endeavor to collect as much location data as possible to maximize the accuracy of the location-based services, while attempting to minimize the associated risks for the privacy of the users particularly as it relates to the inadvertent disclosure or misuse of data. To reduce the privacy risk, location-based service providers may apply privacy-enhancing algorithms on data. Privacy-enhancing algorithms function by removing or altering features of the data that may remove privacy, and this operation typically renders the data less accurate and thus less valuable for the location-based service provider.

One location-based service that presents unique challenges is the problem of parking availability proximate a location. Standard navigation algorithms do not consider parking availability when recommending a route to a user, which may result in a user spending time looking for parking once they have reached their destination. Advanced services can recommend routes with improved chances of finding a parking spot before reaching or proximate the destination. Hence, total driving time, fuel consumption, and emissions can be reduced while providing a greatly-improved user experience. However, such location-based services require computing parking availability estimates for the road segments proximate the destination.

Parking data is defined as a set of events, each of which includes a location identifier (e.g., latitude and longitude) along with a timestamp and possibly a sensory reading. Parking data is produced by vehicles during driving and parking events, and such data may be collected and analyzed by a central backend server, such as that of an OEM (original equipment manufacturer). Parking data is generally some of the most private information available for a user as it can reveal exactly where a vehicle parked and thus reveal behaviors and locations of users and potentially a purpose of a specific trip.

OEMs, which may include vehicle manufacturers, device manufacturers, or software developers/providers, for example, may collect parking data related to a subset of vehicles on a road network. Different OEMs may wish to combine their data with that of other OEMs to obtain more accurate parking availability estimates. However, given the privacy-sensitive nature of parking data, the disclosure of such data introduces privacy risks. Embodiments provided herein provide a privacy-preserving solution to computing parking availability estimates. Embodiments described herein may be employed by a vehicle that generates the parking event data, whereby the vehicle anonymizes its own parking event. Optionally, embodiments may be employed by OEMs that collect parking event data from a subset of vehicles associated with the respective OEM, whereby the OEM can anonymize the parking event data. The OEM may generate parking availability information from the anonymized parking event data. According to some embodiments, two or more OEMs may combine their respective anonymized parking event data to generate parking availability information that is of greater accuracy due to the aggregation of more parking event datapoints.

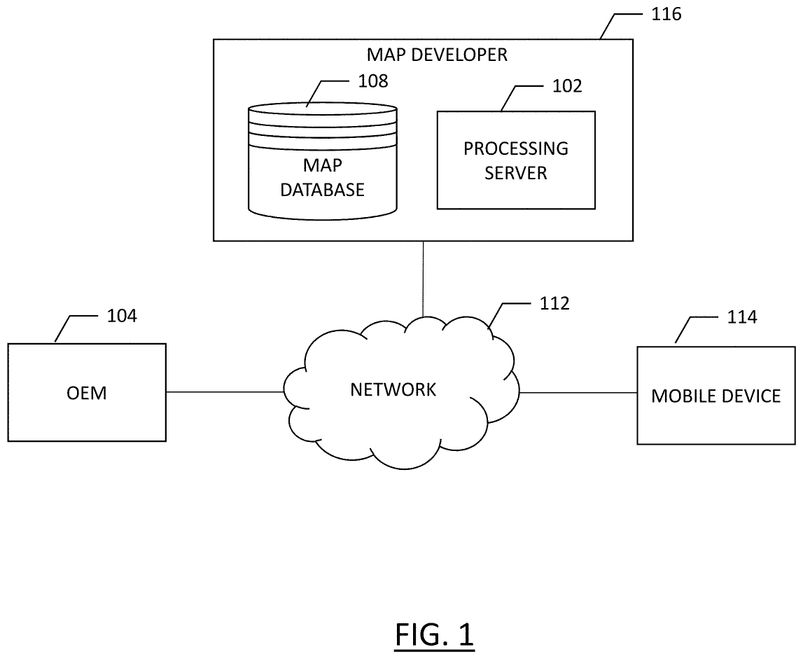

To provide an improved manner of anonymizing parking information associated with a user, a system as illustrated in FIG. 1 may be used. FIG. 1 illustrates a communication diagram of an example embodiment of a system for implementing example embodiments described herein. The illustrated embodiment of FIG. 1 includes a map developer system 116, a processing server 102 in data communication with an original equipment manufacturer (OEM) 104 and/or a geographic map database, e.g., map database 108 through a network 112, and one or more mobile devices 114. The OEM may be one form of a mobility data source from which mobility data of a probe or mobile device is received. The mobility data source may optionally include third party service providers or app developers, for example. The mobile device 114 may be associated, coupled, or otherwise integrated with a vehicle, such as in a vehicle's head unit, infotainment unit, or an advanced driver assistance system (ADAS), for example. Additional, different, or fewer components may be provided. For example, many mobile devices 114 may connect with the network 112. The map developer 116 may include computer systems and network of a system operator. The processing server 102 may include the map database 108, such as a remote map server. The network may be wired, wireless, or any combination of wired and wireless communication networks, such as cellular, Wi-Fi, internet, local area networks, or the like.

The OEM 104 may include a server and a database configured to receive probe data from vehicles or devices corresponding to the OEM. For example, if the OEM is a brand of automobile, each of that manufacturer's automobiles (e.g., mobile device 114) may provide probe data to the OEM 104 for processing. That probe data may be encrypted with a proprietary encryption or encryption that is unique to the OEM. The OEM may be the manufacturer or service provider for a brand of vehicle or a device. For example, a mobile device carried by a user (e.g., driver or occupant) of a vehicle may be of a particular brand or service (e.g., mobile provider), where the OEM may correspond to the particular brand or service. The OEM may optionally include a service provider to which a subscriber subscribes, where the mobile device 114 may be such a subscriber. While depicted as an OEM 104 in FIG. 1, other entities may function in the same manner described herein with respect to the OEM. For example, independent location-based service providers or other entities may participate and contribute in the same manner as described herein with respect to an OEM. As such, the OEM 104 illustrated in FIG. 1 is not limited to original equipment manufacturers, but may be any entity participating as described herein with respect to the OEMs.

The OEM 104 may be configured to access the map database 108 via the processing server 102 through, for example, a mapping application, such that the user equipment may provide navigational assistance to a user among other services provided through access to the map developer 116. According to some embodiments, the map developer 116 may function as the OEM, such as when the map developer is a service provider to OEMs to provide map services to vehicles from that OEM. In such an embodiment, the map developer 116 may or may not be the recipient of vehicle probe data from the vehicles of that manufacturer. Similarly, the map developer 116 may provide services to mobile devices, such as a map services provider that may be implemented on a mobile device, such as in a mapping application. According to such an embodiment, the map developer 116 may function as the OEM as the map developer receives the probe data from the mobile devices of users as they travel along a road network.

The map database 108 may include node data, road segment data or link data, point of interest (POI) data, or the like. The map database 108 may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 108 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 108 can include data about the POIs and their respective locations in the POI records. The map database 108 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 108 can include event data (e.g., traffic incidents, construction activities, scheduled events, unscheduled events, etc.) associated with the POI data records or other records of the map database 108.

The map database 108 may be maintained by a content provider e.g., a map developer. By way of example, the map developer can collect geographic data to generate and enhance the map database 108. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used to generate map geometries directly or through machine learning as described herein.

The map database 108 may be a master map database stored in a format that facilitates updating, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by mobile device 114, for example. The navigation-related functions can correspond to vehicle navigation, pedestrian navigation, or other types of navigation. While example embodiments described herein generally relate to vehicular travel, example embodiments may be implemented for bicycle travel along bike, watercraft travel along maritime navigational routes, etc. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the server side map database 108 may be a master geographic database, but in alternate embodiments, a client side map database 108 may represent a compiled navigation database that may be used in or with end user devices (e.g., mobile device 114) to provide navigation and/or map-related functions. For example, the map database 108 may be used with the mobile device 114 to provide an end user with navigation features. In such a case, the map database 108 can be downloaded or stored on the end user device (mobile device 114) which can access the map database 108 through a wireless or wired connection, such as via a processing server 102 and/or the network 112, for example.

In one embodiment, the mobile device 114 can be an in-vehicle navigation system, such as an ADAS, a personal navigation device (PND), a portable navigation device, a cellular telephone, a smart phone, a personal digital assistant (PDA), a watch, a camera, a computer, and/or other device that can perform navigation-related functions, such as digital routing and map display. An end user can use the mobile device 114 for navigation and map functions such as guidance and map display, for example, and for determination of one or more personalized routes or route segments based on one or more calculated and recorded routes, according to some example embodiments.

An ADAS may be used to improve the comfort, efficiency, safety, and overall satisfaction of driving. Examples of such advanced driver assistance systems include semi-autonomous driver assistance features such as adaptive headlight aiming, adaptive cruise control, lane departure warning and control, curve warning, speed limit notification, hazard warning, predictive cruise control, adaptive shift control, among others. Other examples of an ADAS may include provisions for fully autonomous control of a vehicle to drive the vehicle along a road network without requiring input from a driver. Some of these advanced driver assistance systems use a variety of sensor mechanisms in the vehicle to determine the current state of the vehicle and the current state of the roadway ahead of the vehicle. These sensor mechanisms may include radar, infrared, ultrasonic, and vision-oriented sensors such as image sensors and light distancing and ranging (LiDAR) sensors.

Some advanced driver assistance systems may employ digital map data. Such systems may be referred to as map-enhanced ADAS. The digital map data can be used in advanced driver assistance systems to provide information about the road network, road geometry, road conditions, and other information associated with the road and environment around the vehicle. Unlike some sensors, the digital map data is not affected by the environmental conditions such as fog, rain, or snow. Additionally, the digital map data can provide useful information that cannot reliably be provided by sensors, such as curvature, grade, bank, speed limits that are not indicated by signage, lane restrictions, and so on. Further, digital map data can provide a predictive capability well beyond the driver's vision to determine the road ahead of the vehicle, around corners, over hills, or beyond obstructions. Accordingly, the digital map data can be a useful and sometimes necessary addition for some advanced driving assistance systems. In the example embodiment of a fully-autonomous vehicle, the ADAS uses the digital map data to determine a path along the road network to drive, such that accurate representations of the road are necessary, such as accurate representations of intersections and turn maneuvers there through.

The processing server 102 may receive probe data, directly or indirectly, from a mobile device 114, such as when the map developer is functioning as the OEM 104. Optionally, the map developer 116 may receive probe data indirectly from the mobile device 114, such as when the mobile device 114 provides probe data to the OEM 104, and the OEM provides certain elements of the probe data to the map developer 116. The OEM 104 may anonymize the probe data or otherwise process the probe data to maintain privacy of a user of the mobile device 114 before providing the data to the map developer 116. The mobile device 114 may include one or more detectors or sensors as a positioning system built or embedded into or within the interior of the mobile device 114. Alternatively, the mobile device 114 uses communications signals for position determination. The mobile device 114 may receive location data from a positioning system, such as a global positioning system (GPS), cellular tower location methods, access point communication fingerprinting, or the like. The server 102, either directly or indirectly, may receive sensor data configured to describe a position of a mobile device, or a controller of the mobile device 114 may receive the sensor data from the positioning system of the mobile device 114. The mobile device 114 may also include a system for tracking mobile device movement, such as rotation, velocity, or acceleration. Movement information may also be determined using the positioning system. The mobile device 114 may use the detectors and sensors to provide data indicating a location of a vehicle. This vehicle data, also referred to herein as “probe data”, may be collected by any device capable of determining the necessary information, and providing the necessary information to a remote entity. The mobile device 114 is one example of a device that can function as a probe to collect probe data of a vehicle.

More specifically, probe data (e.g., collected by mobile device 114) may be representative of the location of a vehicle at a respective point in time and may be collected while a vehicle is traveling along a route, at the origin of the route, a destination, or waypoints along the route. According to the example embodiment described below with the probe data being from motorized vehicles traveling along roadways, the probe data may include, without limitation, location data, (e.g. a latitudinal, longitudinal position, and/or height, GPS coordinates, proximity readings associated with a radio frequency identification (RFID) tag, or the like), rate of travel, (e.g. speed), direction of travel, (e.g. heading, cardinal direction, or the like), device identifier, (e.g. vehicle identifier, user identifier, or the like), a time stamp associated with the data collection, or the like. The mobile device 114, may be any device capable of collecting the aforementioned probe data. Some examples of the mobile device 114 may include specialized vehicle mapping equipment, navigational systems, mobile devices, such as phones or personal data assistants, or the like.

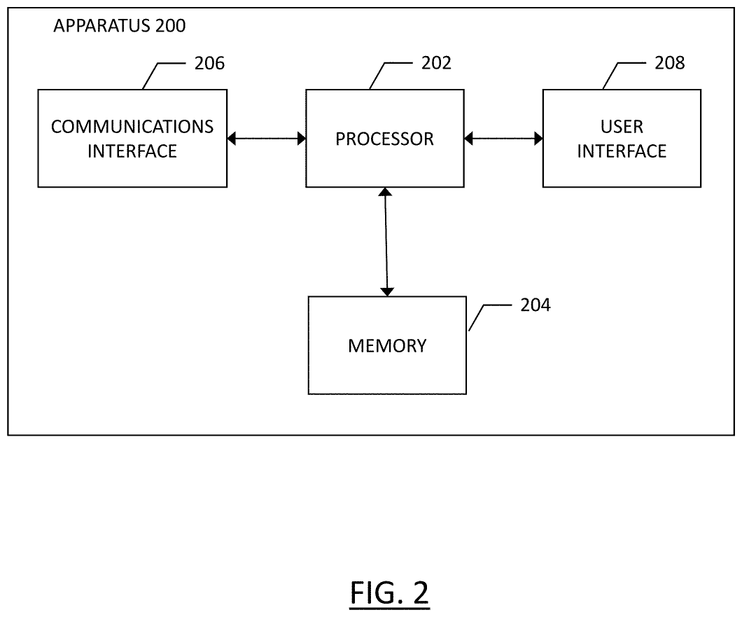

An example embodiment of a processing server 102 and/or an OEM 104 may be embodied in an apparatus as illustrated in FIG. 2. The apparatus, such as that shown in FIG. 2, may be specifically configured in accordance with an example embodiment of the present disclosure for anonymizing trajectories of mobile devices, and more particularly, to segmenting a trajectory and introducing gaps between the trajectory segments or sub-trajectories based on tailored use cases to retain portions of the trajectory that have higher utility. The apparatus may include or otherwise be in communication with a processor 202, a memory device 204, a communication interface 206, and a user interface 208. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor 202). The memory device may be configured to store information, data, content, applications, instructions, or the like, for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the memory device 204 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor specific device (for example, a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 200 of an example embodiment may also include a communication interface 206 that may be any means such as a device or circuitry embodied in either hardware or a combination of hardware and software that is configured to receive and/or transmit data to/from a communications device in communication with the apparatus, such as to facilitate communications with one or more user equipment 104 or the like. In this regard, the communication interface may include, for example, an antenna (or multiple antennae) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 200 may also include a user interface 208 that may in turn be in communication with the processor 202 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processor may comprise user interface circuitry configured to control at least some functions of one or more user interface elements such as a display and, in some embodiments, a plurality of speakers, a ringer, one or more microphones and/or the like. The processor and/or user interface circuitry comprising the processor may be configured to control one or more functions of one or more user interface elements through computer program instructions (for example, software and/or firmware) stored on a memory accessible to the processor (for example, memory device 204, and/or the like).

Parking availability estimates may be offered by service providers that receive parking data from different data sources, such as OEMs, which involves sharing parking data in an original, non-anonymized form. Existing services that work with original parking data from vehicles can risk re-identification of a user from the data, such as when they arrive at or depart a known location, such as their home. Such services may provide parking availability for a specific area around a destination or along a route that ends at a destination. Information about the road network is useful to restrict the area where parking estimates are computed, based on the most important locations for the user (e.g., a driver of a vehicle), given the constraints in the road network (e.g., inaccessible roads due to restrictions or one-way access).

Embodiments provided herein increase the privacy of users that generate parking data, such as park-in and park-out events, by pseudo-randomly displacing the parking event datapoints such that they are less revealing (e.g., further away from where the person actually parked). Adding random displacement aids privacy as it renders the data more difficult to associated with a specific person or by any other person that may be related to the same area (e.g., neighbors). A purely random displacement, which may be produced by adding random noise to the coordinates, would not necessarily improve privacy as the noise may be too small for the context, such as with respect to population density, and the data may be invalid such as when the parking data is placed in an area that has no roads or places to park.

Embodiments provide an algorithm that produce meaningful random perturbation of the data by leveraging information about the road network. Embodiments presume that a user is interested in finding parking along their route proximate the destination, while the specific parking location is not critical as long as it is not too far from the destination. The algorithm may not show a user exact location of parking spots since this information may be unreliable and quickly obsolete; however, the algorithm does provide an indication of promising routes where there is likely to be parking availability. To this end, the algorithm displaces parking events in a way that does not have a large effect on the output of the algorithm in a transparent manner for the users.

Embodiments described herein provide privacy to users of location-based services by adding uncertainty regarding parking events including a “park-in” event where a user parks a vehicle in an available parking spot and a “park-out” event where a user leaves a parking spot making it once more available. An origin including a park-out event, destination such as a park-in event, separately or as a pair, and even portions of a trajectory between the origin and destination, can reveal sensitive locations regarding the user that generated the parking data and trajectory data, such as a home location and/or a work location, a path there between, route preferences, tendencies, or the like. Further, identification of an origin, a destination, or both, may render the identity of the individual user relatively easy to obtain.

Location-based service providers may provide parking availability data to customers, such as drivers/occupants of a vehicle heading to a destination or to municipalities or city planners to help them identify regions where additional parking may be of benefit. Any parking data that reveals a user's behavioral patterns (e.g., going from A to B) can potentially reveal privacy-sensitive information and locations. Embodiments described herein mitigate this issue by anonymizing parking locations including park-in and park-out locations to preserve the privacy of users while providing parking availability data to other users.

Embodiments of the present disclosure anonymize parking data including park-in and park-out events through the use of an intelligent algorithm that pseudo-randomly displaces the parking events such that they are less revealing through being pseudo-randomly distanced away from where the person actually parked. A vehicle or mobile device associated with a vehicle transmits sensor data to a data provider, such as a manufacturer, mobile service provider, or the like, where the sensor data includes parking event information associated to a specific road segment. This data may be highly sensitive as it can reveal an actual or desired parking location of a driver or occupant of a vehicle and potentially reveal sensitive information relating to the driver or occupant.

Embodiments described herein anonymize parking event information while maintaining the utility of the parking event data for use with location-based services. The location-based services may include, for example computing parking availability around a location or parking availability along a route that ends in a specific location. Some areas for parking may be more relevant to a user than others.

According to an example embodiment where the goal is to provide parking availability along a route proximate a destination, there are only a limited number of possible routes that lead to the destination which are constrained by the characteristics of the road network. Similarly, there are only a limited number of routes that can be taken from a location to a destination. Road links that do not belong to these routes are deemed irrelevant for the purpose of producing parking availability estimates according to an example embodiment of the algorithm defined herein. In this way, road segments may be deemed candidate road segments if they are connected, directly or indirectly, to a road segment along which a parking event is map-matched. These candidate road segments are connected to the parking event road segment by virtue of routes or paths that each include the parking event road segment.

Further, some road segments may be more relevant for the location-based service than others. For example, a road segment having a functional class of being a restricted-access highway is not suitable for parking such that even if the road segment qualifies as a candidate road segment, it may not be a road segment to which an updated parking event is associated as described further below. Conversely, a candidate road segment that has a relatively high proportion of parking spaces along the road segment may have a more significant weight, such that it is more likely that a parking event is updated to be associated with the road segment having a high level of parking spaces.

According to example embodiments described herein, an algorithm is to lead a user onto a route with the highest availability of parking. The anonymization algorithm provided herein allows for this goal to be fulfilled by ensuring the output does not change when inputting anonymized data. This is possible by placing anonymized events on a selected subset of road links that would lead the service algorithm to output a route that contains the actual location of the event.

An algorithm as described herein receives input in the form of a parking event. The parking event includes a location (e.g., latitude and longitude) along with a timestamp. Additional information may be provided, such as an indication of whether the event was a park-in event or a park-out event. Optionally, the algorithm may discern whether the parking event was a park-in event or a park-out event based on at least one additional probe data point beyond the parking event data point to imply movement of the vehicle before or after the event. The algorithm map-matches the parking event to a road segment. Using the parking event road segment, candidate road segments may be identified. Candidate road segments are connected directly or indirectly to the parking event road segment and may be part of routes that share the parking event road segment. The parking event road segment may be a common road segment to a plurality of available routes that form the candidate road segments.

According to an example embodiment of the algorithm, the candidate road segments may be reduced and/or weighted based on context. A candidate road segment that does not include any parking spaces, for example, may be eliminated from the set of connected road segments. Candidate road segments may be weighted according to several aspects of the respective road segments. For example, the closer a candidate road segment is to the parking event or the closer a candidate road segment is to a point-of-interest destination, the higher the weight of the respective candidate road segment may be, indicating that it is more likely to be a favorable parking destination. Optionally, candidate road segments that are proximate a higher-density of points-of-interest or points-of-interest of one or more selected categories (e.g, restaurants, retail stores, historical sites, parks, etc.) may be afforded a higher weight than those with a relatively lower density of the same points-of-interest. Similarly, a candidate road segment that has a relatively high level of parking spaces along the respective road segment may be weighted more heavily than a road segment having relatively fewer parking spaces. A functional class of the road segment may also contribute to the weight of the road segment.

Based on the candidate road segments, which may be weighted as described above, a road segment is selected at random from the candidate road segments. While the selection may be substantially “random”, the weighting of the candidate road segments may influence which candidate road segment is selected where more heavily weighted candidate road segments are more likely to be selected than those of a relatively lower weight such that selection of a road segment is pseudo-random.

Further, a distance function may be employed from the parking event which may more heavily weight candidate road segments closer to the parking event. Once a candidate road segment is selected, the parking event is updated to be an updated parking event associated with the selected road segment. The updated parking event may then be provided to a location-based service provider, whereby the parking event may be used to inform a location-based service provider of parking availability in an area.

The candidate road segments may be weighted according to proximity to the parking event, the functional classification of the respective road segment, of the presence of parking spaces along the road segment. Candidate road segments may further be weighted based on a context of the respective road segment. For example, a road segment within a heavily industrial area may be weighted lower than a road segment that is in a commercial area. The context of the area may be established based on map data from the map database 108, for example. Further, weighting of a candidate road segment may be based on a context of population density or parking space density. When considering distance of a road segment from a parking event, the distance factor may change based on context. In a population-dense urban area, the distance factor may be shortened, where road segments within a shorter distance are considered than in a rural area where road segments at a greater distance may be considered as candidate road segments. Candidate road segments in an urban environment may have a substantially higher weight closer to the parking event as the density of the population provides some degree of anonymity and privacy. In a rural or suburban area, candidate road segments closest to the parking event may not have a substantially higher weight than those further from the parking event as the lack of dense population may not provide substantial anonymity.

This pseudo-random selection of a candidate road segment generates specially-crafted noise where parking events will not appear to be generated on the road segment where they actually occurred, but will lead a parking availability estimation algorithm to provide a similar result as if non-anonymized parking event data would be used as input. For example, if an event appears N road segments before or after where the parking event actually is, and the proposed route doesn't change, the user of the location-based service will be led onto the same route and will eventually find the available parking.

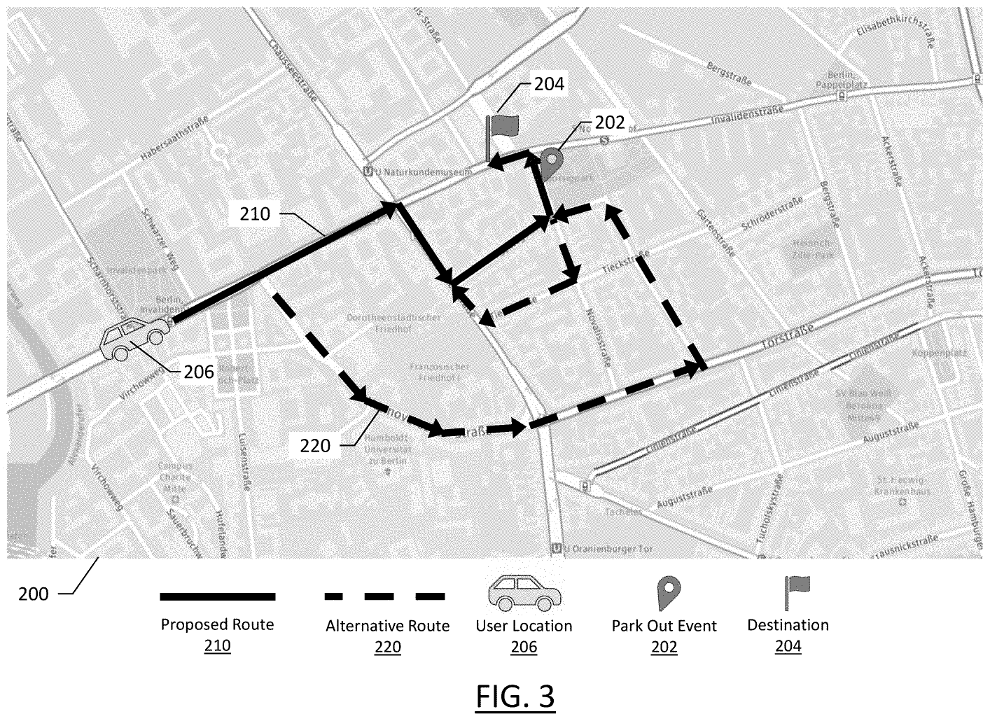

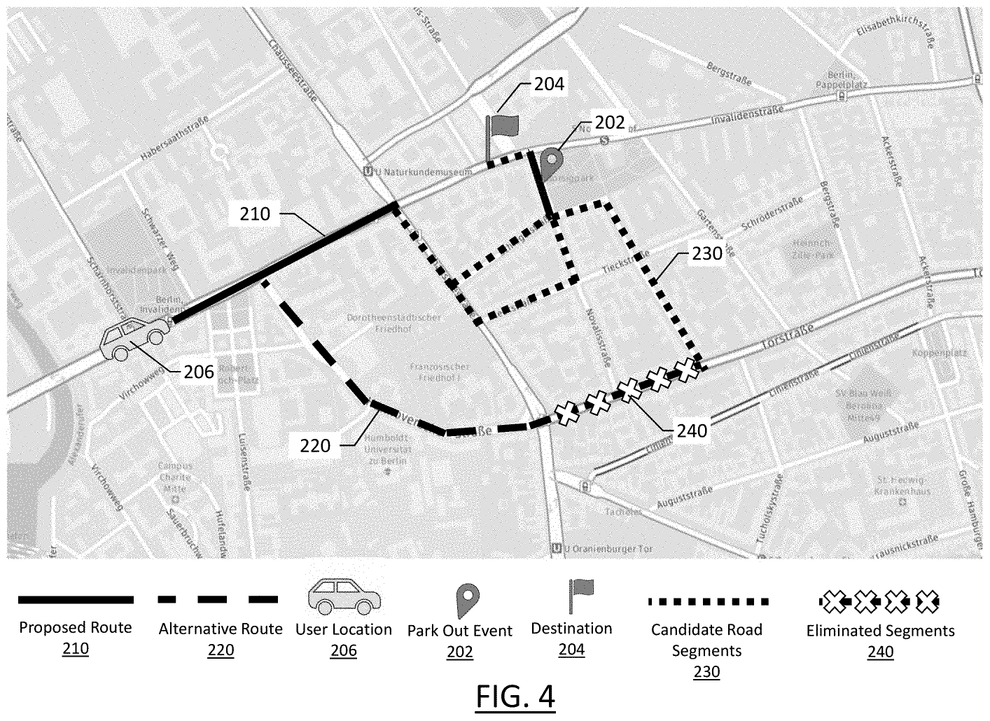

FIG. 3 illustrates a map 200 depicting a location of a parking event 202 proximate a destination 204 of a user. The parking event 202 is unrelated to the user positioned at the user location 206; however, the parking event 202 is a park-out event proximate the destination 204 of the user. A proposed route 210 to the destination is relatively direct, while an alternative route 220 is available that may provide better opportunities to find available parking based on the park-out parking event 202. Both routes include the road segment map-matched to the parking event 202 such that if either route is suggested to the driver or operator of a vehicle, the driver or operator will guide the vehicle along the road segment where the parking event 202 occurred, and have the opportunity to park in the free parking space indicated by the parking event. FIG. 4 illustrates candidate road segments 230 where the parking event 202 may be updated to be matched to. The connected road segments 230 are road segments that fall along routes to the destination 204 and are connected, directly or indirectly, to the road segment along which the parking event 202 occurs. While the candidate road segments 230 are shown to be potential locations for the updated parking event, connected road segment 240 is eliminated as a potential location for the updated parking event. This may be due to the eliminated candidate road segment 240 being too far from the destination 204. Alternatively or additionally, the eliminated road segment 240 may not have parking spaces along the road segment such that it is eliminated as a contender for the updated parking event.

While the example embodiment of FIGS. 3 and 4 reflect a park-out event, example embodiments provided herein may similarly function for a park-in event. In the case of a park-in event, a location-based service provider may recognize the reduction in available parking spaces and may base a location-based service on such an event including where an anonymized park-in event suggests that parking in the vicinity is reduced. In the case of a park-out event, candidate road segments may be identified relative to the park-out event and a candidate road segment may be selected for the anonymized park-out event.

According to an example embodiment described herein, a location-based service provider or an OEM receives raw parking event data. The raw parking event data may be anonymized by the OEM or the location-based service provider. When a user requests a route to a destination, the route may be generated by the OEM or location-based service provider, or on-board a vehicle (or user's mobile device) informed by the OEM or location-based service provider as would be done when considering traffic between an origin and a destination. The OEM or location-based service provider may anonymize the raw parking event data and based on the anonymized parking event data, provide one or more recommended routes to the user to improve the likelihood of the user finding parking proximate their destination.

The route of a user may be generated by a location-based service provider to pass through road segments having a relatively higher likelihood of having parking spaces which is informed by embodiments of the present disclosure. As such, using parking events as described herein, the alternative route 220 of FIG. 3 may be provided to the user at the user location 206 to guide them along road segments that are likely to provide an available parking space. The specific parking event 202, while anonymized to become an updated parking event along a road segment that is not the actual road segment map-matched to the parking event still provides valuable parking availability information for location-based services. The intelligent algorithm as described above provides a mechanism by which parking availability can be estimated with a reasonable degree of accuracy given the considerations of the algorithm and the input of the parking events in the area of the road segments considered for the updated parking event.

The raw parking event data may be provided to an OEM, such as OEM 104 of FIG. 1, whereby the OEM performs the anonymization of the parking event. However, according to some embodiments, anonymization may be performed by the mobile device 114, such as on-board the vehicle (e.g., using the mobile device associated with the vehicle). Anonymization performed on-board the vehicle can optionally enable sending of anonymized parking data directly to location-based service providers without divulging the actual location of the parking event of the user. Alternatively, anonymization performed on-board the vehicle can be provided to the OEM to be used for location based service provisioning. A parking event may be anonymized at the vehicle by pseudo-randomly selecting a candidate road segment within a radius centered an actual park-in or park-out event location according to the algorithm described above.

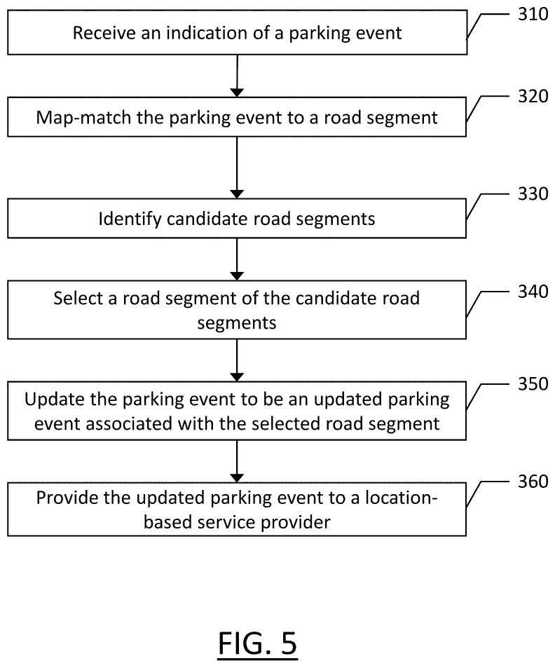

FIG. 5 illustrates a flowchart depicting methods according to an example embodiments of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 204 of an apparatus employing an embodiment of the present invention and executed by a processor 202 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

FIG. 5 illustrates a method of anonymizing parking event information from a source and using the anonymized parking event to facilitate location-based services. In the illustrated embodiment, an indication of a parking event is received at 310. The parking event may be received, for example, a vehicle or mobile device 114. The parking event may include a location (e.g., latitude and longitude) and a time stamp, for example. The parking event is map-matched at 320 to a parking event road segment of a road network. Candidate road segments are identified at 330, where identifying candidate road segments may entail weighting the candidate road segments according to various weighting criteria, such as distance from the parking event, road segment functional class, parking space density or presence along a road segment, or the like. A road segment of the candidate road segments is selected pseudo-randomly at 340. At 350, the parking event is updated to be an updated parking event associated with the selected road segment. The updated parking event is provided to a location-based service provider at 360 to facilitate the provision of location-based services.

In an example embodiment, an apparatus for performing the method of FIG. 5 above may comprise a processor (e.g., the processor 202) configured to perform some or each of the operations (310-360) described above. The processor may, for example, be configured to perform the operations (310-360) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 310-360 may comprise, for example, the processor 202 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and computer program code configured to, with the processor, cause the apparatus to at least:
receive an indication of a parking event;
map-match the parking event to a parking event road segment;
identify candidate road segments, wherein the candidate road segments are connected directly or indirectly to the parking event road segment;
select a road segment of the candidate road segments;
update the parking event to be an updated parking event associated with the selected road segment; and
provide the updated parking event to a location-based service provider.

2. The apparatus of claim 1, wherein causing the apparatus to provide the updated parking event to a location-based service provider comprises causing the apparatus to enable the location-based service provider to use the updated parking event in establishing available parking within a road network.

3. The apparatus of claim 1, wherein the candidate road segments comprise road segments of routes that include the parking event road segment.

4. The apparatus of claim 1, wherein the candidate road segments are afforded a weight, wherein causing the apparatus to select the road segment of the candidate road segments comprises causing the apparatus to select the road segment of the candidate road segments based, at least in part, on the weights of the candidate road segments.

5. The apparatus of claim 4, wherein the weight is based, at least in part, on a functional class of a respective candidate road segment.

6. The apparatus of claim 4, wherein the weight is based, at least in part, on a presence of parking spaces along a respective candidate road segment.

7. The apparatus of claim 1, wherein the selected road segment of the candidate road segments is selected based, at least in part, on a distance from the parking event road segment.

8. The apparatus of claim 1, wherein the candidate road segments are identified based, at least in part, on road network information from map data.

9. A computer program product comprising at least one non-transitory computer-readable storage medium having computer-executable program code portions stored therein, the computer-executable program code portions comprising program code instructions configured to:
receive an indication of a parking event;
map-match the parking event to a parking event road segment;
identify candidate road segments, wherein the candidate road segments are connected directly or indirectly to the parking event road segment;
select a road segment of the candidate road segments;
update the parking event to be an updated parking event associated with the selected road segment; and
provide the updated parking event to a location-based service provider.

10. The computer program product of claim 9, wherein the program code instructions to provide the updated parking event to a location-based service provider comprise program code instructions to enable the location-based service provider to use the updated parking event in establishing available parking within a road network.

11. The computer program product of claim 9, wherein the candidate road segments comprise road segments of routes that include the parking event road segment.

12. The computer program product of claim 9, wherein the candidate road segments are afforded a weight, wherein the program code instructions to select the road segment of the candidate road segments comprise program code instructions to select the road segment of the candidate road segments based, at least in part, on the weights of the candidate road segments.

13. The computer program product of claim 12, wherein the weight is based, at least in part, on a functional class of a respective candidate road segment.

14. The computer program product of claim 12, wherein the weight is based, at least in part, on a presence of parking spaces along a respective candidate road segment.

15. The computer program product of claim 9, wherein the selected road segment of the candidate road segments is selected based, at least in part, on a distance from the parking event road segment.

16. The computer program product of claim 9, wherein the candidate road segments are identified based, at least in part, on road network information from map data.

17. A method comprising:
receiving an indication of a parking event;
map-matching the parking event to a parking event road segment;
identifying candidate road segments, wherein the candidate road segments are connected directly or indirectly to the parking event road segment;
selecting a road segment of the candidate road segments;
updating the parking event to be an updated parking event associated with the selected road segment; and
providing the updated parking event to a location-based service provider.

18. The method of claim 17, wherein providing the updated parking event to a location-based service provider comprises enabling the location-based service provider to use the updated parking event in establishing available parking within a road network.

19. The method of claim 17, wherein the candidate road segments comprise road segments of routes that include the parking event road segment.

20. The method of claim 17, wherein the candidate road segments are afforded a weight, wherein selecting the road segment of the candidate road segments comprises selecting the road segment of the candidate road segments based, at least in part, on the weights of the candidate road segments.
